(19) United States
(12) Patent Application Publication
(10) Pub. No.: US 2026/0099925 A1
(43) Pub. Date: Apr. 9, 2026

(54) LABEL UNIFORMING METHOD BASED ON MULTIPLE OBJECT TRACKING AND VOTING AND VIDEO ACQUISITION SYSTEM

(71) Applicant: IRONYUN INC., Zhubei City (TW)

(72) Inventors: Jenn-Shiuan WENG, Zhubei City (TW); Peng-Jung WU, Zhubei City (TW)

(73) Assignee: IRONYUN INC., Zhubei City (TW)

(21) Appl. No.: 18/909,365

(22) Filed: Oct. 8, 2024

(51) Int. Cl. G06T 7/20; G06V 20/54; G06V 20/70

(52) U.S. Cl. CPC G06T 7/20; G06V 20/54; G06V 20/70; G06V 2201/07

(57) ABSTRACT

A label uniforming method based on multiple object tracking and voting and a video acquisition system are disclosed. The label uniforming method includes steps of: receiving a video segment, wherein the video segment contains multiple frames; keeping track of an object throughout the frames in the video segment by multiple object tracking (MOT); for each of the frames in the video segment, labeling the object with an inference label; generating counts corresponding to multiple categories; determining a uniform label corresponding to the category that has the highest count; and updating the inference label for the object in each of the frames as the uniform label for the object. By using the label uniforming method, the object would have a uniformed label throughout all the frames, and thus the object is labeled consistently without a need to provide additional training materials to train an AI model.

### BACKGROUND OF THE INVENTION

### 1. Field of the Invention

The present invention relates to a label management method and system, more particularly a label uniforming method based on multiple object tracking and voting and a video acquisition system.

### 2. Description of the Related Art

As deep learning methods evolve through years of innovations, a field of video recognition also enjoy leaps of development. A development in the field of video recognition emphasizes the importance of identifying and inferring objects present within a video segment.

For video recognition to work through deep learning means, a vast amount of training data, such as files containing training labels, and great length of video footages are needed to train an artificial intelligence (AI) model to successfully identify an object. However, while object identification is widely accomplished by many AI models, most AI models fail to accurately specify a category that the object belongs to. A reason for such failure is attributed to the fact that training materials for an AI model to identify an object often do not label the category of the object unless a clear correspondence is present, and hence when training to identify the object under different video conditions with the aforementioned training materials, such as to identify the object under different viewing angles, different brightness, and different blurriness, the AI model is unable to consistently infer the category of the object. For the AI model to consistently infer the model of the object, one would have to drastically increase the amount of training material multiple-folds for training the AI model to train with additional labels of the categories, and thus cannot be done by simpler means.

To help the AI model to more consistently and successfully infer a category of the object without adding multiple-folds of training material to the AI model's training regime, a new label uniforming method is needed for the video footage of the object.

### SUMMARY OF THE INVENTION

The present invention provides a label uniforming method based on multiple object tracking and voting and a video acquisition system.

The label uniforming method of the present invention manages inference labels of an object that is being tracked throughout different frames of a video segment by updating the labels to be uniform for the object throughout the video segment. As such, a uniform label for the object outputted by the label uniforming method of the present invention is consistent throughout the video segment without requiring to re-train any artificial intelligence (AI) models.

The label uniforming method based on multiple object tracking and voting is executed by a processor unit, and the label uniforming method includes the following steps:
receiving a video segment, wherein the video segment contains multiple frames;
keeping track of an object throughout the frames in the video segment by multiple object tracking (MOT);
for each of the frames in the video segment, labeling the object with an inference label;
generating counts corresponding to multiple categories;
determining a uniform label corresponding to the category that has the highest count; and
updating the inference label for the object in each of the frames as the uniform label for the object.

A video acquisition system is configured to execute label uniforming method. The video acquisition system includes:
at least one camera unit, recording a video segment; wherein the video segment contains multiple frames;
a processor unit, connected to the at least one camera unit; wherein the processor unit:
receives the video segment from the at least one camera unit;
keeps track of an object throughout the frames in the video segment by multiple object tracking (MOT);
for each of the frames in the video segment, labels the object with an inference label;
generates counts corresponding to multiple categories;
determines a uniform label corresponding to the category that has the highest count; and
updates the inference label for the object in each of the frames as the uniform label for the object.

By generating the counts corresponding to the categories, determining a uniform label corresponding to the category that has the highest count and updating the inference label for the object in each of the frames as the uniform label for the object, the processor unit that executes the label uniforming method essentially conducts a virtual election for voting the categories of the object and electing the uniform label for the object based on the highest count of the categories. As such, given limited input of the frames of the video segment, the elected uniform label for the object throughout the frames of the video segment would be the most probable and hence most reliable inference choice for the object throughout the frames of the video segment without having to re-train any AI models. In other words, when an inadequately trained AI model is initially used for labeling the object with inconsistent inference labels throughout the frames of the video segment, without having to re-train the AI model to be more adequate with great consumption of time and training materials, the processor unit that executes the label uniforming method of the present invention is able to swiftly and cost-efficiently uniform all the inference labels throughout the frames to be the uniform label.

By having the object in the video efficiently labeled with the uniform label, the video segment not only presents reliable, consistent, and accurate information about the object for a user, but also serves as excellent training material for subsequently training an AI model to be more adequate in differentiating the categories of the object.

### BRIEF DESCRIPTION OF THE DRAWINGS

FIG. 1 is a flow chart of a label uniforming method based on multiple object tracking and voting of the present invention.

FIG. 2 is an embodiment of a video acquisition system of the present invention that executes the label uniforming method.

FIG. 3 is another embodiment of the video acquisition system of the present invention that executes the label uniforming method.

FIG. 4 is a perspective view of a display unit displaying a frame of a video segment acquired by the video acquisition system that executes the label uniforming method of the present invention.

FIGS. 5A to 5D are perspective views of frames of the video segment having an object under different conditions for the label uniforming method of the present invention.

FIG. 6 is another flow chart of the label uniforming method of the present invention.

FIGS. 7A to 7D are perspective views of frames of the video segment having the object labeled by the label uniforming method of the present invention.

FIG. 8 is another flow chart of the label uniforming method of the present invention.

### DETAILED DESCRIPTION OF THE INVENTION

The present invention provides a label uniforming method based on multiple object tracking and voting and a video acquisition system that executes the label uniforming method.

The label uniforming method manages inconsistent inference labels of an object throughout multiple frames of a video segment by updating the inconsistent inference labels to be uniform throughout the frames of the video segment. As such, the label uniforming method allows for a consistent recognition of the object throughout the frames of the video segment.

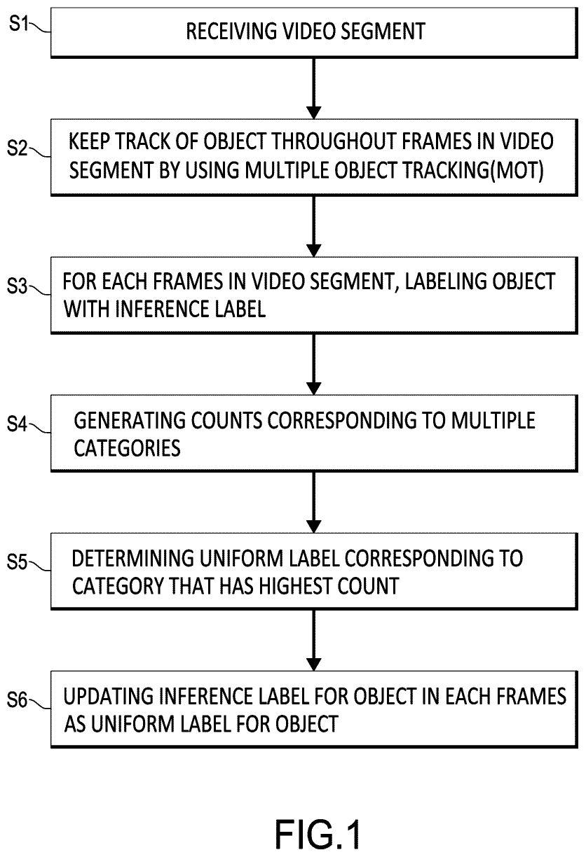

With reference to FIG. 1, the label uniforming method based on multiple object tracking and voting includes the following steps:

Step S1: receiving a video segment, wherein the video segment contains multiple frames.

Step S2: keeping track of an object throughout the frames in the video segment by multiple object tracking (MOT).

Step S3: for each of the frames in the video segment, labeling the object with an inference label.

Step S4: generating counts corresponding to multiple categories.

Step S5: determining a uniform label corresponding to the category that has the highest count.

Step S6: updating the inference label for the object in each of the frames as the uniform label for the object.

By executing step S4 and step S6, the label uniforming method essentially conducts a virtual election for voting the categories of the object and electing the uniform label for the object based on the highest count of the categories. As such, given limited input of the frames of the video segment, the elected uniform label for the object throughout the frames of the video segment would be the most probable and hence most reliable inference choice for the object throughout the frames of the video segment without having to re-train any AI models. In other words, when an inadequately trained AI model is initially used for labeling the object with inconsistent inference labels throughout the frames of the video segment, without having to re-train the AI model to be more adequate with great consumption of time and training materials, the label uniforming method of the present invention is able to swiftly and cost-efficiently update and uniform all the inference labels throughout the frames to be the uniform label.

By having the object in the video efficiently labeled with the uniform label, the video segment not only presents reliable, consistent, and accurate information about the object for a user, but also serves as excellent training material for subsequently training an AI model to be more adequate in differentiating the categories of the object. The label uniforming method of the present invention helps saving human resources conventionally dedicated to re-training the inadequately trained AI model with human-noted labels to training videos. In other words, apart from producing instantly usable results to identify the object consistently for the user, the present invention also saves a cost of human labors for creating training materials for AI models to learn about the object and the category of the object. The object in the video segment may be any arbitrary entity that is animate or inanimate. The category of the object may be any information or feature regarding the object, such as a type of the object or a model of the object, etc.

The video acquisition system of the present invention, that executes the label uniforming method, includes a processor unit and at least one camera unit. The at least one camera unit records a video segment, wherein the video segment contains multiple frames. The processor unit is connected to the at least one camera unit. The processor unit receives the video segment from the at least one camera unit; keeps track of an object throughout the frames in the video segment by multiple object tracking (MOT); for each of the frames in the video segment, labels the object with an inference label; generates counts corresponding to multiple categories; determines a uniform label corresponding to the category that has the highest count; and updates the inference label for the object in each of the frames as the uniform label for the object.

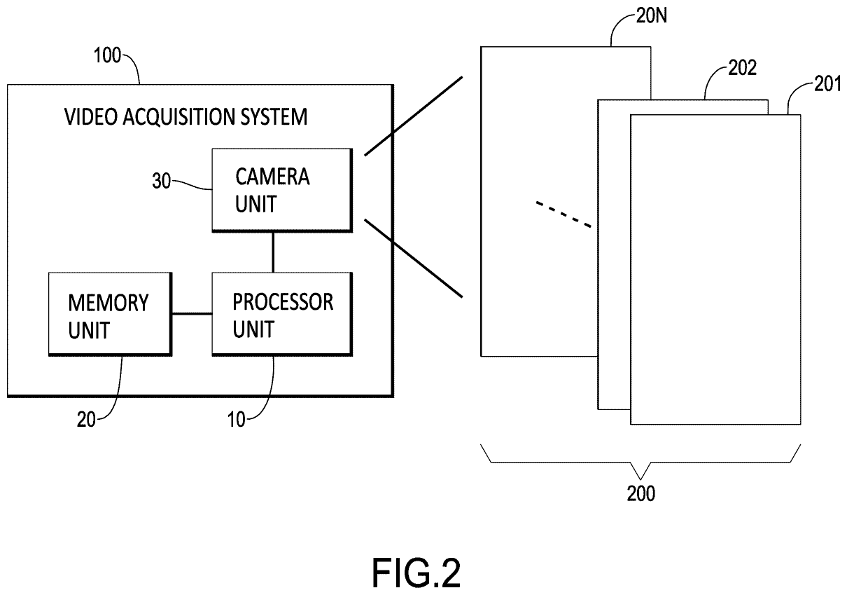

With reference to FIG. 2, in an embodiment, the label uniforming method is being executed by a video acquisition system 100. More particularly, the video acquisition system 100 includes a processor unit 10, a memory unit 20, and a camera unit 30. The processor unit 10 is electrically connected to the memory unit 20 and the camera unit 30, and the processor unit 10 is configured to execute the label uniforming method. The camera unit 30 captures a video segment 200, and the video segment 200 includes multiple frames. For example, the video segment 200 includes N frames, wherein N is an integer greater than 2. The N frames include a first frame 201, a second frame 202, and a last frame 20N. An object is present in the multiple frames of the video segment 200, and is being tracked by the MOT.

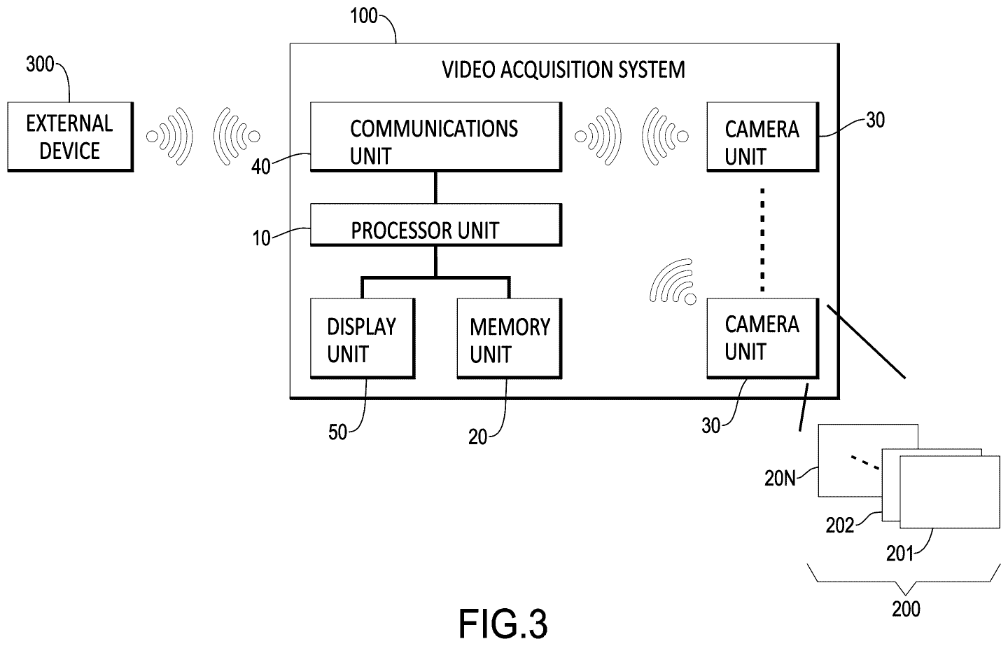

With reference to FIG. 3, in another embodiment, the label uniforming method is still being executed by the processor unit 10 of the video acquisition system 100, but the video acquisition system 100 is configured differently. In the present embodiment, a plurality of the camera units 30 are wirelessly connected to a communications unit 40, and the communications unit 40 is electrically connected to the processor unit 10. The video segment 200 is captured by one of the camera units 30. Furthermore, a display unit 50 is also electrically connected to the processor unit 10. The processor unit 10 controls the display unit 50 to display the video segment 200 captured by one of the camera units 30 in real-time. The processor unit 10 also controls the communications unit 40 to share this real-time displayed footage of the video segment 200 to an external device 300 wirelessly connected to the communications unit 40. The external device 300 may be any device capable of maintaining wireless connections, such as any type of smart portable devices or computers. Smart portable devices include smart phones, smart glasses, or VR/AR headsets. Computers include desktops, tablets, or laptops.

Once the label uniforming method executes the aforementioned steps S1 to S5, the video segment 200 shared to the display unit 50 and the external device 300 would have the label of high reliability throughout all the frames. Although in this case the video segment 200 is technically no longer displaying in real-time on the display unit 50 and the external device 300, the video segment 200 is still being displayed on the display unit 50 and the external device 300 with minimal time delay. This is because the label uniforming method of the present invention can be efficiently executed by the processor unit 10, and thus appears to label the video segment 200 almost instantly.

In practice and in the context of the present invention, the category of the object often lacks exposure to be labelled together with the object, and for this reason a generic AI model used for object recognition may only identify what the object is rather than more specifically what category the object belongs to. For example, in a context of vehicle identification, training materials provided to most AI models for training to identify a car on the road generally include all angles of the car under different weather conditions. However, only when the logo of the car is present would the training material specify the brand of the car in clear correspondence to the logo. As a result, most AI models only identify a car on a road, but cannot consistently identify a brand the car belongs to. Furthermore, as the front and the rear of the car contain logos of the car's brand, footages of the front and the rear of the car often do allow the AI model to successfully infer the brand of the car. However, as labels regarding the brand of the car is lacking to train the AI model to identify the brand of the car under all circumstances regarding different viewing angles, different brightness, and different blurriness, the AI model would most likely fail to identify the brand of the car when the car is turned side-ways without showing its logo. This means that when a car is turning, such as making a U-turn, the AI model can only identify the car's brand during instances when the front of the car and the rear of the car are respectively present in the video footage. When the car is turned side-ways in the video footage, the AI model starts guessing the car's brand wildly and outputting inconsistent and incorrect answers. In the said context of vehicle identification, an embodiment of the present invention is able to resolve the aforementioned issues. The label uniforming method of the present invention can also be applied to other different contexts for managing the inference labels given to the object in the frames of the video segment, and thus no matter the context the label uniforming method is in, providing benefits of updating the inference label of each of the frames to be the uniform label.

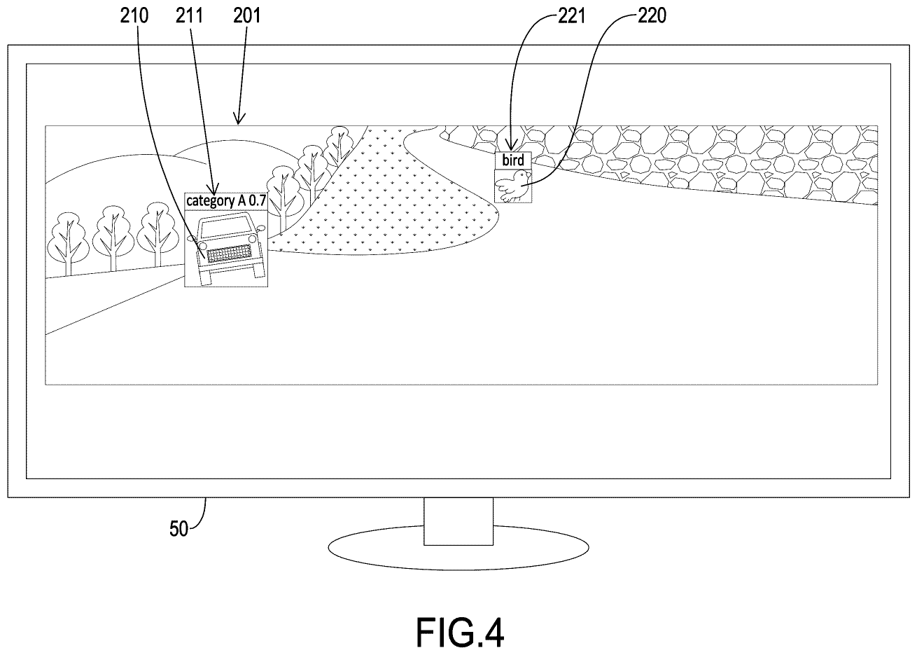

With reference to FIG. 4, in an embodiment, the display unit 50 is a monitor, and the camera unit 30 capturing the first frame 201 of the video segment 200 is a surveillance camera. The first frame 201 is being displayed by the display unit 50 to the first user in FIG. 4, and within the first frame 201, a first object 210 and a second object 220 are being tracked by the MOT for their motions. The first object 210 and the second object 220 are respectively labeled with an inference label of their own. A first inference label 211 corresponding to the first object 210 indicates that the first object 210 is inferred to be a car, and a second inference label 221 corresponding to the second object 220 indicates that the second object 220 is inferred to be a flying bird.

A user-defined voting model and an object recognition model are used for generating the first inference label 211 for the first object 210, and generating the second inference label 221 for the second object 220. In other words, when the processor unit 10 executes the label uniforming method, the processor unit 10 also utilizes the user-defined voting model and the object recognition model that are saved in the memory unit 20.

The object recognition model is pre-trained using a deep learning method to recognize the object in any video segments. However, just like most generic AI models, the object recognition model is only generically trained to identify objects rather than providing more detail information about the category the object belongs to under all circumstances. In other words, the object recognition model is able to identify the first object 210 as a car, and the second object 220 as a bird, but the object recognition model is unable to reliably identify a category of the car, such as a car model of the car, under all circumstances of a footage of the video segment. Nevertheless, the object recognition model assists the user-defined voting model to identify the object in the video segment.

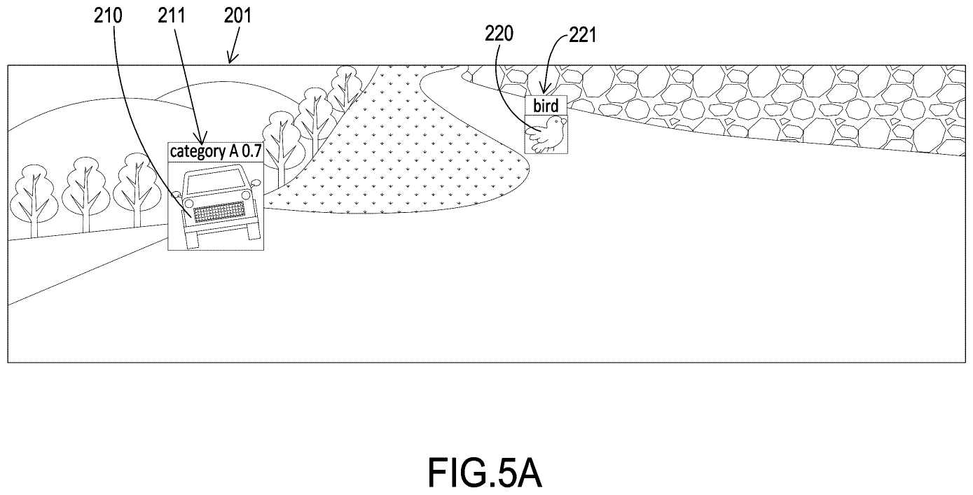

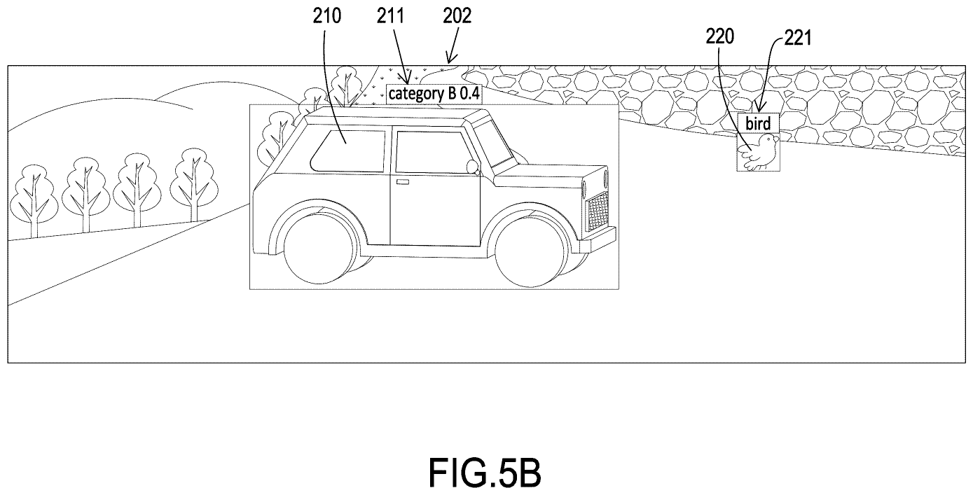

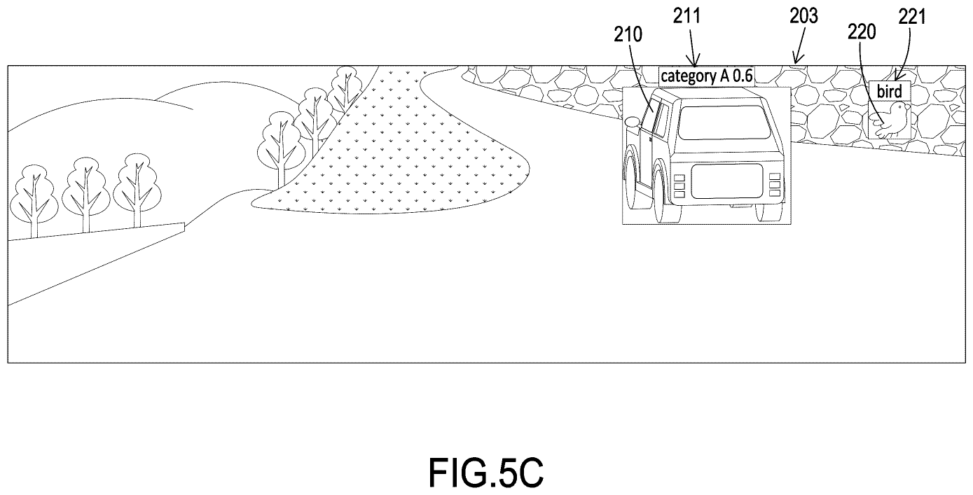

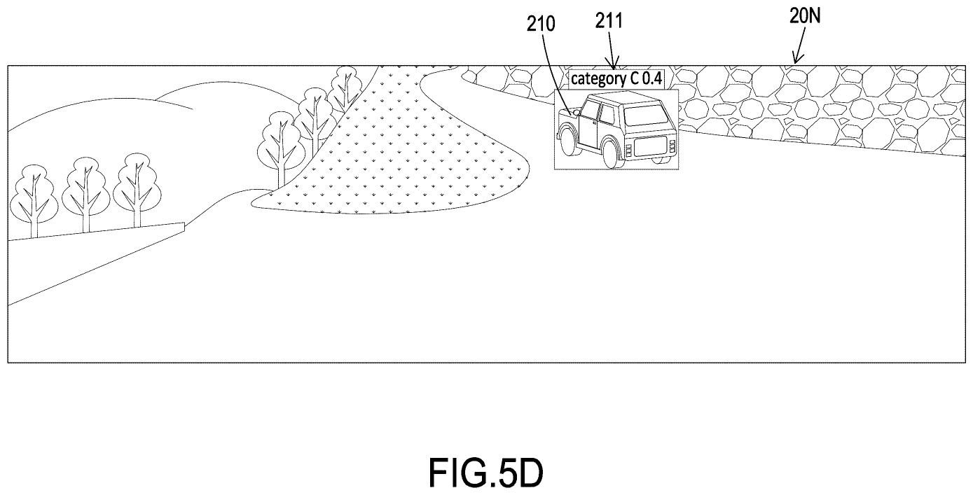

With reference to FIGS. 5A to 5D, the processor unit 10 is able to keep track of a plurality of objects through different frames with the MOT, and each of the objects is individually and independently tracked by the processor unit 10. In an example, the video segment of a car making a U-turn on the road is shown along with a bird flying across the road. The first object 210 and the second object 220 are being tracked by the MOT throughout the first frame 201, the second frame 202, a third frame 203, and the last frame 20N. The processor unit 10 is also able to differentiate the objects, such as differentiating the first object 210 being a car from the second object 220 being a bird.

Since both the first object 210 and the second object 220 are present in multiple frames, the MOT respectively forms an object identification group for the first object 210 and another object identification group for the second object 220 to keep track of the respective objects under different viewing angles, different brightness, and different blurriness throughout the frames in the video segment 200. By having different object identification groups, the first object 210 is also individually and independently labeled from the second object 220. In this embodiment, since the bird is not an object of interest to the user, the user utilizes the label uniforming method of the present invention to only make label corrections regarding the first inference labels 211, hence managing the first inference labels 211, present throughout the different frames.

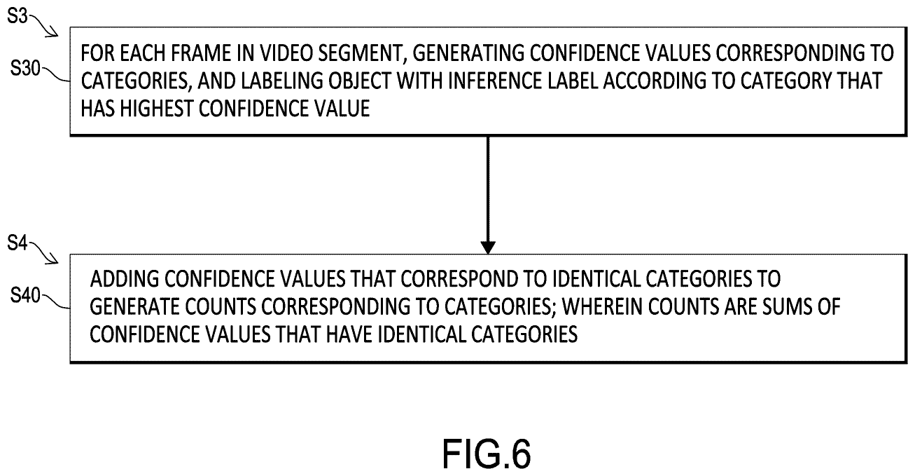

With reference to FIG. 6, the user-defined voting model is used when labeling the object with the inference label and generating the counts corresponding to the multiple categories. The user-defined voting model may be programmed by the user for customizing how exactly to calculate and generate the counts corresponding to the categories. In an embodiment, step S3 of the user-defined voting model includes the following sub-step:

Step S30: for each of the frames in the video segment, generating confidence values corresponding to the categories, and labeling the object with the inference label according to the category that has the highest confidence value. Wherein the confidence values corresponding to the categories are generated according to the said object recognition model.

Subsequently, step S4 of the user-defined voting model includes the following sub-step:

Step S40: adding the confidence values that correspond to identical categories to generate the counts corresponding to the categories; wherein the counts are sums of the confidence values that have the identical categories.

Regarding FIGS. 5A to 5D, by executing step S30, the first object 210 is inferenced to be the following entities in different frames according to Table 1:

TABLE 1

| | | The first inference |
|---|---|---|
| | Information of the object | label 211 with the |
| | inferred with confidence | highest confidence |
| | values (soft label | value (highest soft |
| | probabilities): | label probability): |
| In the first frame 201: | Car of: | category A 0.7 |
| | category A: 0.7 | |
| | category B: 0.2 | |
| | category C: 0.1 | |
| In the second frame 202: | Car of: | category B 0.4 |
| | category A: 0.3 | |
| | category B: 0.4 | |
| | category C: 0.3 | |
| In the third frame 203: | Car of: | category A 0.6 |
| | category A: 0.6 | |
| | category B: 0.2 | |
| | category C: 0.2 | |
| In the last frame 20N: | Car of: | category C 0.4 |
| | category A: 0.3 | |
| | category B: 0.3 | |
| | category C: 0.4 | |

By executing step S30, the category with the highest confidence value in each individual frame is set as the first inference label 211 for the first object 210 in each individual frame. For example, in the first frame 201 of FIG. 5A, the first object 210 is inferred 100% chance to be the car and 0% chance to be the bird, furthermore, the first object 210 is inferred 70% chance to be the car of category A, 20% chance to be the car of category B, and 10% chance to be the car of category C. Since the first object 210 is most probable to be the car of category A in regards to the first frame 201, the first inference label 211 displays the most 10 probable category along with the corresponding confidence value as “category A 0.7” in the first frame 201. By applying the same logic to all the frames, the present invention gathers the following result:
The first object 210 in the first frame 201 has the first inference label 211 and the highest confidence value labeled as category A 0.7.
The first object 210 in the second frame 202 has the first inference label 211 and the highest confidence value labeled as category B 0.4.
The first object 210 in the third frame 203 has the first inference label 211 and the highest confidence value labeled as category A 0.5.
The first object 210 in the last frame 20N has the first inference label 211 and the highest confidence value labeled as category C 0.4.

Since the logo of the car is present in the first frame 201 in front of the car and in the third frame 203 at the rear of the car, the model of the car is inferenced more correctly as category A. Vise versa, since the logo of the car is absent in the second frame 202 at a side of a car and in the last frame 20N at another side of the car, the model of the car is inferred incorrectly as category B or category C. This is hardly a surprising result, as prior arts would have made the same mistakes inferencing results based on the sides of the car instead of the front or the rear of the car. In other words, the surveillance camera is viewing the car with changing brightness, changing blurriness, and most notably, changing angles throughout the frames shown through FIGS. 5A to 5D. As the car changes its angles facing towards the surveillance camera that captures the video segment 200, the car challenges the object recognition model for its inference correctness.

In order to correct and uniform the inconsistent inference labels of the car with the uniform label, the present invention conducts a voting process for all possible results of the first inference label 211 throughout the frames of the video segment with the user-defined voting model.

By executing step S40, the confidence values that have identical categories are summed into the counts. In the current embodiment of the present invention, all possible inference probabilities of the first inference label 211 throughout the frames of the video segment are participants of the voting process. In the voting process, the candidates are the categories, and the candidates receive votes as a total of all the inference probabilities associated to them. The votes are hereby known as the counts. In other words, in this embodiment, all confidence values (soft label probabilities) throughout the frames are summed as votes, and the counts of the added votes account all the inference probabilities. All of the confidence values throughout the plurality of frames are accounted for generating the counts corresponding to all of the categories. For example, please reference the following:

TABLE 2

| | First | Second | Third | Last | Added votes as |
|---|---|---|---|---|---|
| | frame: | frame: | frame: | frame: | the counts: |
| Votes for | 0.7 | 0.3 | 0.6 | 0.3 | 1.9 |
| category A: | | | | | |
| Votes for | 0.2 | 0.4 | 0.2 | 0.3 | 1.1 |
| category B: | | | | | |
| Votes for | 0.1 | 0.3 | 0.2 | 0.4 | 1.0 |
| category C: | | | | | |

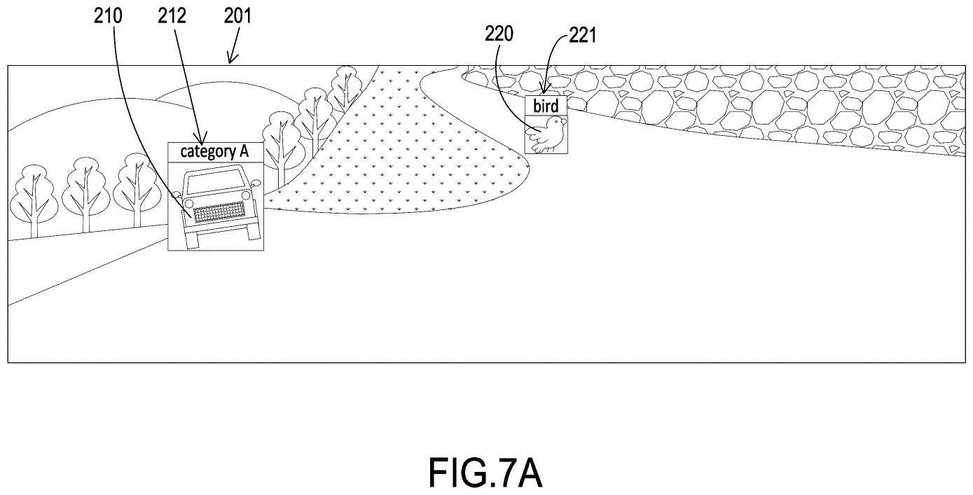

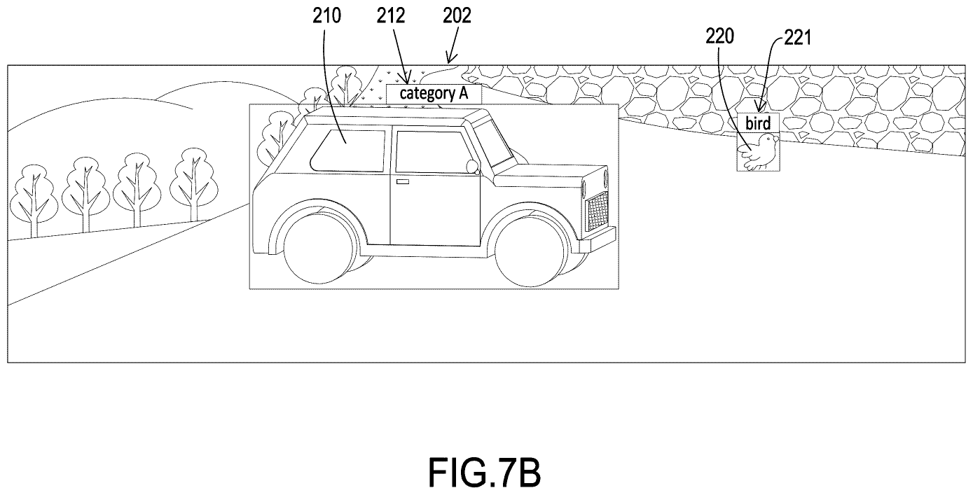

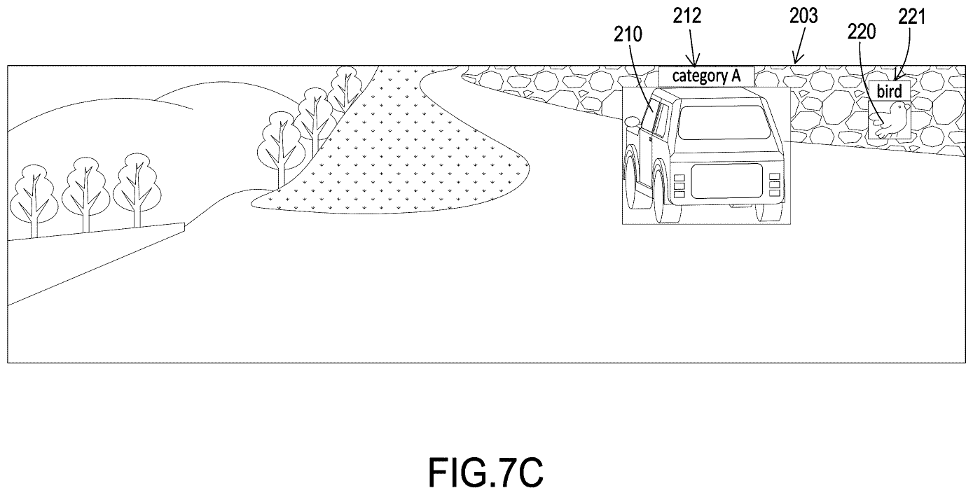

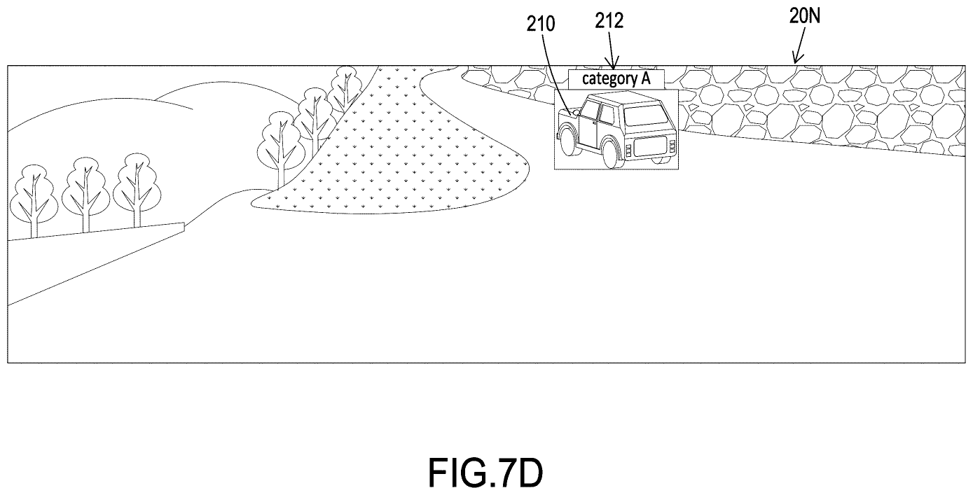

As a result, the voting process in the above example ended with category A having the highest vote, and hence the first inference labels 211 throughout all of the frames of the video segment are uniformed as having uniform labels 212 as category A as shown in FIGS. 7A to 7D.

In another embodiment of the present invention, when executing step S40, the confidence values that have identical categories are summed into the counts. However, only the first inference label 211 with the highest confidence value (highest soft label probability) are participating in the voting process. In other words, only the highest confidence value of each of the frames are summed as votes, and the counts of the added votes only account the inference probabilities that are most significant in each of the frames. Only the highest confidence value of each of the frames are accounted for generating the counts corresponding to the categories. In an example, the results shown in Table 1 are used to produce the voting process as detailed in the following:

TABLE 3

| | First | Second | Third | Last | Added votes as |
|---|---|---|---|---|---|
| | frame: | frame: | frame: | frame: | the counts: |
| Votes for | 0.7 | | 0.6 | | 1.3 |
| category A: | | | | | |
| Votes for | | 0.4 | | | 0.4 |
| category B: | | | | | |
| Votes for | | | | 0.4 | 0.4 |
| category C: | | | | | |

As a result, the voting process in the above example also ended with category A having the highest vote, and hence the first inference labels 211 throughout all of the frames of the video segment are uniformed as having uniform labels 212 as category A as shown in FIGS. 7A to 7D.

For each of the frames, the confidence values corresponding to different categories would rarely have identical values. In the rare occasion the confidence values corresponding to different categories have identical values in a specific frame, the processor unit 10 may try to re-generate the confidence values for the specific frame, or omit counting the confidence value for the specific frame into the count.

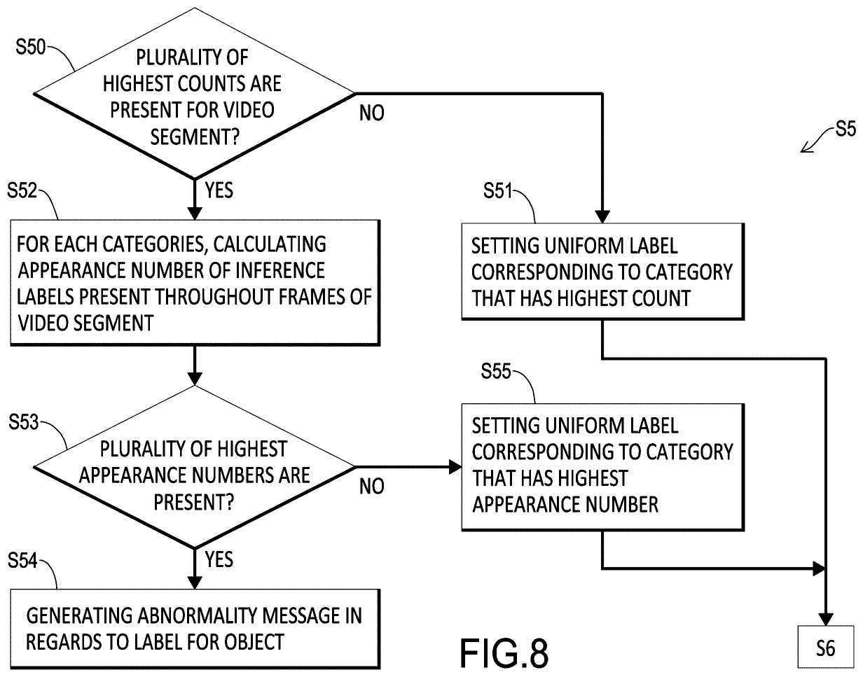

With reference to FIG. 8, the counts generated by the label uniforming method for all the different categories, in rare occasions, might also have identical values. To resolve this, the label uniforming method further includes the following steps for step S5:

Step S50: determining whether a plurality of the highest counts are present for the video segment.

Step S51: when determining the highest count is singular, setting the uniform label corresponding to the category that has the highest count, and subsequently executing step S6.

Step S52: when determining the plurality of the highest counts are present, for each of the categories, calculating an appearance number of the inference labels present throughout the frames of the video segment.

Step S53: determining whether a plurality of the highest appearance numbers are present for the video segment.

Step S54: when determining the plurality of the highest appearance numbers are present, generating an abnormality message in regards to the inference labels for the object.

In an embodiment, the abnormality message is generated by the processor unit 10, and the abnormality message may be a text message displayed on the display unit 50 or the external device 300, indicating that a rare occurrence of a genuinely indistinguishable object is presented in the video segment.

Step S55: when determining the highest appearance number is singular, setting the uniform label corresponding to the category that has the highest appearance number, and subsequently executing step S6.

In other words, the present invention may conduct more than one voting process, in regards to the highest count and the highest appearance number, to respectively decide which of the categories of the object is most suitable to be elected as the uniform label 212 for the object.

With reference to FIGS. 7A to 7D, as Table 2 shows that the highest count is singular, the uniform label 212 is swiftly applied to all frames in the video segment as the category A. The uniform label 212 only depicts the category of the object without depicting the corresponding count in each frame, because as the label uniforming method had already uniformed the identification result for the category of the object, the counts are no longer needed to be presented to a user of the present invention. Regarding the example of the first object 210 being a car, the car is uniformed to be of category A because category A is voted and selected by the present invention to ascend from one of the multiple categories to be the first label that is uniformed by the uniform label 212. As the uniform label 212 is reliably, consistently, and accurately labeled in every frame of the video segment 200, the user of the present invention would be able to easily and efficiently distinguish the category of the object from the video segment 200.

Furthermore, the video segment 200, having the uniform label 212 labeled consistently by the present invention, allows the AI model to learn to associate the category A of the car with all different viewing angles and all different sides of the car, with or without logos indicating the model of the car.

What is claimed is:

1. A label uniforming method based on multiple object tracking and voting, executed by a processor unit, comprising the following steps:
receiving a video segment, wherein the video segment comprises multiple frames;
keeping track of an object throughout the frames in the video segment by multiple object tracking (MOT);
for each of the frames in the video segment, labeling the object with an inference label;
generating counts corresponding to multiple categories;
determining a uniform label corresponding to the category that has the highest count; and
updating the inference label for the object in each of the frames as the uniform label for the object.

2. The label uniforming method as claimed in claim 1, wherein the object being tracked by the MOT is a car, and the inference labels are different models of the car;
wherein the categories are also different models of the car, and the uniform label is a unified identification of the model of the car.

3. The label uniforming method as claimed in claim 2, wherein the video segment is taken by a surveillance camera, and throughout the frames of the video segment, the surveillance camera views the car with changing angles, changing brightness, and changing blurriness.

4. The label uniforming method as claimed in claim 1, wherein a user-defined voting model is used when labeling the object with the inference label and generating the counts corresponding to the multiple categories;
wherein the user-defined voting model executes the following sub-steps:
for each of the frames in the video segment, generating confidence values corresponding to the categories, and labeling the object with the inference label according to the category that has the highest confidence value;
adding the confidence values that correspond to identical categories to generate the counts corresponding to the categories; wherein the counts are sums of the confidence values that have the identical categories.

5. The label uniforming method as claimed in claim 4, wherein when adding the confidence values that correspond to identical categories to generate the counts corresponding to the categories, all of the confidence values throughout the plurality of frames are accounted for generating the counts corresponding to the categories.

6. The label uniforming method as claimed in claim 4, wherein when adding the confidence values that correspond to identical categories to generate the counts corresponding to the categories, only the highest confidence value of each of the frames are accounted for generating the counts corresponding to the categories.

7. The label uniforming method as claimed in claim 4, wherein the user-defined voting model further executes the following sub-step:
when a plurality of the highest counts are present, for each of the categories, calculating an appearance number of the inference labels present throughout the frames of the video segment, and setting the uniform label corresponding to the category that has the highest appearance number.

8. The label uniforming method as claimed in claim 7, wherein the user-defined voting model further executes the following sub-step:
when a plurality of the highest appearance numbers are present, generating an abnormality message in regards to the inference labels for the object.

9. The label uniforming method as claimed in claim 4, wherein the confidence values corresponding to the categories are generated according to an object recognition model;
wherein the object recognition model is pre-trained using a deep learning method to recognize the object.

10. A video acquisition system, comprising:
at least one camera unit, recording a video segment; wherein the video segment contains multiple frames;
a processor unit, connected to the at least one camera unit; wherein the processor unit:
receives the video segment from the at least one camera unit;
keeps track of an object throughout the frames in the video segment by multiple object tracking (MOT);
for each of the frames in the video segment, labels the object with an inference label;
generates counts corresponding to multiple categories;
determines a uniform label corresponding to the category that has the highest count; and
updates the inference label for the object in each of the frames as the uniform label for the object.

11. The video acquisition system as claimed in claim 10, further comprising:
a communications unit, electrically connected to the processor unit, and wirelessly connected to the at least one camera unit;
wherein the processor unit is connected to the at least one camera unit through the communications unit;
wherein the communications unit is configured to connect to an external device, and the processor unit outputs a footage of the video segment to the external device through the communications unit.

12. The video acquisition system as claimed in claim 10, further comprising:
a display unit, electrically connected to the processor unit; wherein the processor unit controls the display unit to display the video segment.

13. The video acquisition system as claimed in claim 10, wherein the object being tracked by the MOT is a car, and the inference labels are different models of the car;
wherein the categories are also different models of the car, and the uniform label is a unified identification of the model of the car.

14. The video acquisition system as claimed in claim 13, wherein the at least one camera unit is a surveillance camera, and throughout the frames of the video segment, the surveillance camera views the car with changing angles, changing brightness, and changing blurriness.

15. The video acquisition system as claimed in claim 10, further comprising:
a memory unit, electrically connected to the processor unit, storing a user-defined voting model; wherein the user-defined voting model is used by the processor unit when labeling the object with the inference label and generating the counts corresponding to the multiple categories;
wherein the user-defined voting model executes the following sub-steps:
for each of the frames in the video segment, generating confidence values corresponding to the categories, and labeling the object with the inference label according to the category that has the highest confidence value;
adding the confidence values that correspond to identical categories to generate the counts corresponding to the categories; wherein the counts are sums of the confidence values that have the identical categories.

16. The video acquisition system as claimed in claim 15, wherein when adding the confidence values that correspond to identical categories to generate the counts corresponding to the categories, all of the confidence values throughout the plurality of frames are accounted for generating the counts corresponding to the categories.

17. The video acquisition system as claimed in claim 15, wherein when adding the confidence values that correspond to identical categories to generate the counts corresponding to the categories, only the highest confidence value of each of the frames are accounted for generating the counts corresponding to the categories.

18. The video acquisition system as claimed in claim 15, wherein the user-defined voting model further executes the following sub-step:
when a plurality of the highest counts are present, for each of the categories, calculating an appearance number of the inference labels present throughout the frames of the video segment, and setting the uniform label corresponding to the category that has the highest appearance number.

19. The video acquisition system as claimed in claim 18, wherein the user-defined voting model further executes the following sub-step:
when a plurality of the highest appearance numbers are present, generating an abnormality message in regards to the inference labels for the object.

20. The video acquisition system as claimed in claim 15, wherein the memory unit stores an object recognition model, and the confidence values corresponding to the categories are generated according to the object recognition model;
wherein the object recognition model is pre-trained using a deep learning method to recognize the object.
